(19) United States
(12) Patent Application Publication
(10) Pub. No.: US 2007/0069022 A1
(43) Pub. Date: Mar. 29, 2007

(54) Wireless communication system and method

(75) Inventors: Shigeru Hatakeyama, Tokyo (JP); Shigeru Yamazaki, Tokyo (JP); Hiroki Murayama, Tokyo (JP); Koichi Hirano, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/520,786

(22) Filed: Sep. 14, 2006

(30) Foreign Application Priority Data
Sep. 27, 2005 (JP) 2005-280775

(51) Int. Cl. G06K 7/08

(52) U.S. Cl. 235/451

(57) ABSTRACT

A plurality of electromagnetic wave areas is provided to form a data channel between a wireless IC chip and a main antenna. The plurality of electromagnetic wave areas is placed along a traveling direction of the wireless IC chip, and comprises an electromagnetic wave area at a first stage in which an electromagnetic wave is radiated from front of a traveling direction of the wireless IC chip, an electromagnetic wave area at a middle stage in which an electromagnetic wave is radiated in a direction intersecting with a traveling direction of the wireless IC chip, and an electromagnetic wave area at a last stage in which an electromagnetic wave is radiated from a rear of a traveling direction of the wireless IC chip.

### BACKGROUND OF THE INVENTION

1. Field of the Invention

The present invention relates to a wireless communication system and a method therefor where a communication is performed by reading/writing, for example, between wireless IC chips attached to articles piled up stereoscopically and a main antenna.

2. Description of the Related Art

There has been required a device that is capable of collectively obtaining and managing information about articles piled up on a floor or a dolly in a store or a factory, or information about articles piled up on a dolly passing through a passage in a store or a production line. It becomes possible to manage a plurality of articles collectively through attaching RFID tags to the plurality of articles and reading out the information on the RFID tags or writing information of the articles to the RFID tags by a reader/writer.

Japanese Patent Application Laid-open No. 2005-4532 discloses a configuration in which a plurality of antennas is arranged circumferentially around a turntable mounting a wireless data carrier. Japanese Patent Application Laid-open No. 2000-341170 discloses an antenna switching system in a file retention and management system utilizing an RFID technology, of which a configuration has a plurality of antennas set for a single antenna driving circuit in order to communicate with a data carrier, and an antenna is switched and connected to the antenna driving circuit by an antenna switching unit.

### SUMMARY OF THE INVENTION

The wireless communication system disclosed in Japanese Patent Application Laid-open No. 2005-4532 in the above, is certainly capable of radiating an electromagnetic wave toward a RFID tag of an article on a turntable when a configuration thereof has a plurality of antennas are arranged circumferentially around a turntable.

However, according to Japanese Patent Application Laid-open No. 2005-4532 in the above, electromagnetic waves radiated from antennas to articles on a turntable are directed to one point, so that electromagnetic waves cannot be irradiated onto RFID tags depending upon positions of the RFID tags in a piled up state of articles. For example, assuming that an RFID tag at the beginning position of the rotation is inclined toward the right, a RFID tag at the middle position of the rotation is inclined upward, and a RFID tag at the end position of the rotation is inclined toward the left. In this case, even if there is a plurality of antennas, only RFID tags with a facing direction corresponding to the facing directions of the antennas can respond to electromagnetic waves from those antennas because radiating directions of electromagnetic waves from the antennas are directed to one point. Because every RFID tag which faces random directions is not able to respond to electromagnetic waves from the antennas, improvement is required.

Further, in Japanese Patent Application Laid-open No. 2000-341170, a plurality of antennas are switched and connected to an antenna driving circuit, and a condition is required where articles with RFID tags are need to be arranged on a shelf and the like in good order. Therefore, the configuration of antennas shown in Japanese Patent Application Laid-open No. 2000-341170 is required to be improved for RFID tags piled up at random in order to respond to an electromagnetic wave from the antenna.

An object of the present invention is to provide a wireless communication system and a method to establish data channels by electromagnetic waves certainly between wireless IC chips attached to articles and the like and a main antenna.

In order to achieve the foregoing object, the wireless communication system according to the present invention comprising:

a plurality of electromagnetic wave areas for forming a data channel between a wireless IC chip and a main antenna; wherein

the plurality of electromagnetic wave areas are arranged along a traveling direction of the wireless IC chip, and the plurality of electromagnetic wave areas has,

an electromagnetic wave area at a first stage in which an electromagnetic wave is radiated from a front of the traveling direction of the wireless IC chip,

an electromagnetic wave area at a middle stage in which an electromagnetic wave is radiated in a direction intersecting with the traveling direction of the wireless IC chip, and

an electromagnetic wave area at a last stage in which an electromagnetic wave is radiated from a rear of the traveling direction of the wireless IC chip.

In this case, radiation in the electromagnetic wave area at the middle stage is desirably set at least in two directions intersecting with the traveling direction of the wireless IC chip.

According to the present invention, a wireless IC chip attached to an article and the like travels along a plurality of electromagnetic wave areas. When a wireless IC chip travels in the electromagnetic wave areas, electromagnetic waves are radiated from front of the traveling direction of the wireless IC chip in the electromagnetic wave area at the first stage, electromagnetic waves are radiated in a direction intersecting with the traveling direction of the wireless IC chip in the electromagnetic wave area at the middle stage, and electromagnetic waves are radiated from a rear of the traveling direction of the wireless IC chip in the electromagnetic wave area at the last stage.

As described in the above, according to the present invention, electromagnetic waves are radiated from different directions along the traveling direction of the wireless IC chip, so that a ratio of establishing a data channel between a wireless IC chip and a main antenna is increased significantly. Because of this, data communication can be performed certainly between a wireless IC chip and a main antenna even if the wireless IC chips are piled up at random.

Moreover, electromagnetic waves are radiated all over even onto wireless IC chips facing inappropriate directions to establish a data channel in the electromagnetic wave areas at the first stage and the last stage because the electromagnetic waves are radiated from at least in two directions intersecting with the traveling direction of a wireless IC chip.

Also, when electromagnetic waves are radiated in two directions in the electromagnetic wave area at the middle stage, a reflecting plate may be utilized to reflect electromagnetic waves radiated from the main antenna toward the traveling direction of the wireless IC chip. In this case, the main antenna may be disposed taking reflecting plate as a unit.

Main antennas for radiating electromagnetic wave may be disposed at every electromagnetic wave area, or a single main antenna which moves around every electromagnetic wave area may be disposed. In this case, a unit is provided to synchronize radiation of the electromagnetic waves from a main antenna in the plurality of electromagnetic wave areas with travel of a wireless IC chip and to switch the radiation.

According to the present configuration, a configuration of main antennas can be selected adequately depending on installation sites for main antennas. Thus, the wireless communication system can be set wherever a main antenna is disposed.

For performing a communication by establishing a data channel by an electromagnetic wave between a wireless IC chip and a main antenna utilizing the wireless communication system according to the present invention, a configuration thereof comprises the steps of:

a preliminary process in which the wireless IC chip travels into a plurality of electromagnetic wave areas sequentially; and

a communication process in which an electromagnetic wave is radiated from different directions at every electromagnetic wave area toward the wireless IC chip that has traveled into the electromagnetic wave areas, wherein

an electromagnetic wave is radiated from front of a traveling direction of the wireless IC chip in an electromagnetic wave area at a first stage among the plurality of electromagnetic wave areas,

an electromagnetic wave is radiated from a direction intersecting with a traveling direction of the wireless IC chip in an electromagnetic wave area at a middle stage among the plurality of electromagnetic wave areas, and

an electromagnetic wave is radiated from a rear of a traveling direction of the wireless IC chip in an electromagnetic wave area at a last stage among the plurality of electromagnetic wave areas. In this case, an electromagnetic wave is desirably radiated from at least two directions intersecting with the traveling direction of the wireless IC chip.

Radiation of electromagnetic waves in the plurality of electromagnetic wave areas are desirably synchronized with the travel of a wireless IC chip and to be switched, whereby an electromagnetic wave for data communication can be radiated onto a wireless IC chip while electromagnetic waves in different electromagnetic wave areas are prevented from interfering with each other.

Additionally, an electromagnetic wave is desirably radiated from different directions by main antennas which are disposed in the respective electromagnetic wave areas, or to be radiated from different directions at every electromagnetic wave area by a single main antenna moving around the plurality of electromagnetic wave areas. Also, in the electromagnetic wave area at the middle stage, electromagnetic waves are desirably to be radiated from at least two directions intersecting with a traveling direction of the wireless IC chip.

As described in the above, according to the present invention, electromagnetic waves are radiated from different directions along a traveling direction of a wireless IC chip, and thereby a data channel can be formed certainly between every wireless IC chip and a main antenna even if a plurality of wireless IC chips disperse

stereoscopically in a wide range and face random directions.

### BRIEF DESCRIPTION OF THE DRAWINGS

FIG. 1 is a side view showing a wireless communication system according to a first embodiment of the present invention.

FIG. 2 is a front view showing an electromagnetic wave area at a middle stage area viewed from a traveling direction of a RFID tag according to a first embodiment of the present invention.

FIG. 3 is a side view showing the wireless communication system according to a second embodiment of the present invention.

FIG. 4 is a front view showing an electromagnetic wave area at a middle stage viewed from a traveling direction of a RFID tag according to a second embodiment of the present invention.

### DESCRIPTION OF THE PREFERRED EMBODIMENTS

Hereinafter, embodiments of the present invention will be explained with reference to the accompanying drawings.

As a fundamental structure, the wireless communication system according to the embodiments of the present invention comprises a plurality of electromagnetic wave areas E1, E2 and E3 to form data channels between wireless IC chips 3 and main antennas (21-24). The plurality of electromagnetic wave areas E1, E2, and E3 is arranged along the traveling direction of the wireless IC chip 3, and has an electromagnetic wave area E1 at a first stage in which electromagnetic waves are radiated from front of the traveling direction of the wireless IC chip, an electromagnetic wave area E2 at a middle stage in which electromagnetic waves are radiated from a direction intersecting with the traveling direction of the wireless IC chip, and an electromagnetic wave area E3 at a last stage in which electromagnetic waves are radiated from a rear of the traveling direction of the wireless IC chip.

Main antennas 21-24 are to radiate electromagnetic waves outputted from transceivers 11, 12, 13 and 14 toward the wireless IC chip 3. The embodiments of the present invention will be explained specifically with reference to the cases where a reader/writer is used as a transceiver to manage an RFID tag 3 which is used as a wireless IC chip. Here, an RFID tag comprises an antenna, a memory and so on. A reader/writer 3 has functions of reading information from the RFID tag 3 and writing information in the RFID tag with an electromagnetic wave. A reader/writer 1 is to perform transmitting/receiving data signals made of electromagnetic waves to/from the RFID tag 3 using its main antenna 2. The RFID tags and reader/writers used above are widely-used types.

### FIRST EMBODIMENT

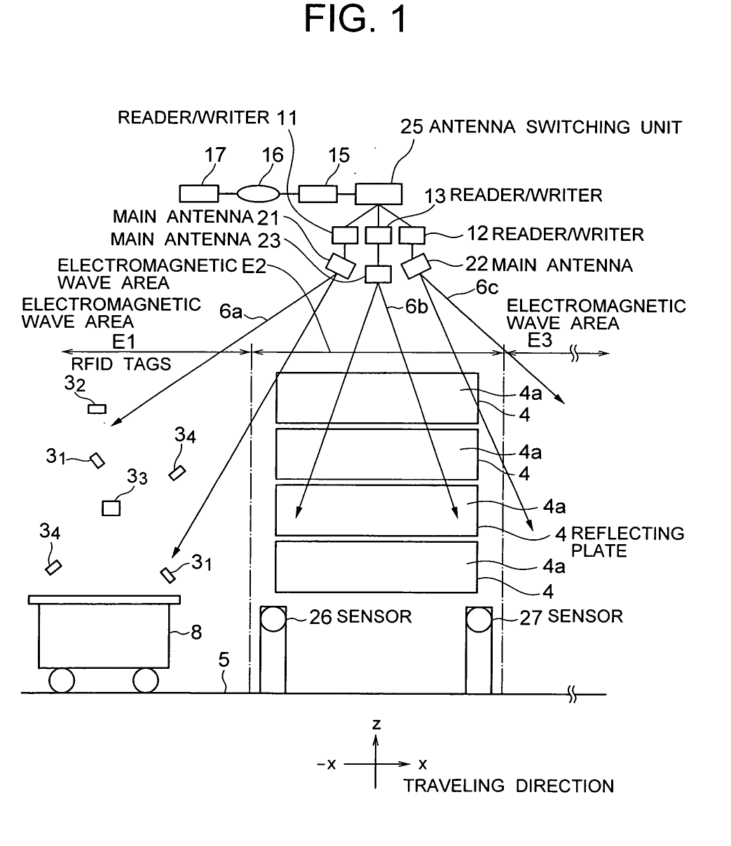

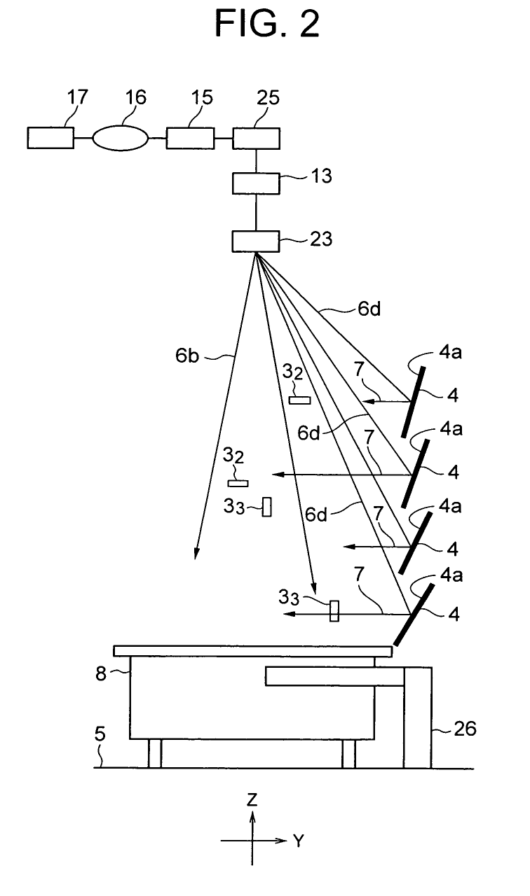

A first embodiment of the present invention will be presented by FIGS. 1 and 2. As shown in FIGS. 1 and 2, articles to which the RFID tags 3 are attached are piled up on a dolly 8 and conveyed on a conveying path 5. The conveying path 5 is set in stores and in warehouses in a distribution process, or along passages in stores and production lines. The point is the conveying path 5 can be set anywhere as far as the conveying path 5 is set for traveling the RFID tags 3 attached to articles piled up on the dolly 8 sequentially through a plurality of electromagnetic wave areas E1, E2 and E3. Also, the conveying path 5 is not necessarily a straight line, but also may be curved in an arc. Note that articles piled up on the dolly 8 are not illustrated in figures, but only the RFID tags 3 attached to the articles are illustrated therein.

With reference to the RFID tags 3, one article may have a plurality of the RFID tags 3 attached thereto, or a plurality of articles may have one RFID tag 3 or a plurality of the RFID tags 3 attached thereto. When the articles to which the RFID tags 3 are attached are piled up on the dolly 8, antenna surfaces of the RFID tags 3 may be directed to random directions depending on a piled up state of the articles. In specifically, as shown in FIG. 1, when the articles which are not illustrated are piled up on the dolly 8, there may be the RFID tags intermingled with each other depending on the piled up state of the articles; the RFID tag 3₁ facing from the X axis direction to the Z axis direction, that is, the antenna surface thereof inclines with facing to the upper right, the RFID tag 3₂ facing at the Z axis direction, that is, the antenna surface thereof is directed to right above, the RFID tag 3₃ facing at the Y axis direction, that is, the antenna surface thereof faces sideways, and the RFID tag 3₄ facing from the −X axis direction to the Z axis direction, that is, the antenna surface thereof inclines with facing to the upper left.

A level of electromagnetic waves received by the RFID tags 3 is varied by the path lengths from main antennas 21-23 to the RFID tags 3, and by the direction of electromagnetic wave radiations from the main antennas 21-23 and the facing direction of antenna surfaces of the RFID tags 3. When it is assumed in the case where the antenna of the RFID tag 3 is the monopole antenna or the dipole antenna that the length of the antenna of the RFID tag 3 viewed from the radiating direction of the electromagnetic waves is the reception effective length and assumed in the case where the antenna is the flat antenna that the area of the antenna surface of the RFID tag 3 viewed from the radiating direction of the electromagnetic waves is the reception effective area, the reception effective length or the reception effective area becomes the maximum when the radiating direction is vertical to the antenna surface of the RFID tag 3, and the level of the received electromagnetic waves becomes the maximum value.

In the case that there are the RFID tags 3₁, 3₂ and 3₃ antenna surfaces of which are facing random directions intermingled with each other, when it is assumed that data communication is performed by a single main antenna fixed on such as a ceiling, the main antenna can establish a data channel by electromagnetic waves therefrom between the main antenna and the RFID tag 3₂ of which an antenna surface faces right above. However, with respect to the RFID tags other than 3₂, that is, 3₁ and 3₃, it is impossible to establish data channels by electromagnetic waves from the main antenna.

So, in the embodiment of the present invention shown in FIG. 1, three electromagnetic wave areas are placed and these electromagnetic wave areas E1, E2 and E3 are arranged along the conveying path 5. The electromagnetic wave area E1 at the first stage has the main antenna 21 which radiates the electromagnetic waves 6a that come from the reader/writer 11, the electromagnetic wave area E2 at the middle stage has the main antenna 23 which radiates the electromagnetic waves 6b that come from the reader/writer 13, and the electromagnetic wave area E3 at the last stage has the main antenna 22 which radiates the electromagnetic waves 6c that come from the reader/writer 12 respectively. The main antennas 21, 22, and 23 are set all together on such as a ceiling of a building above the conveying path 5.

The main antenna 21 is set such that a radiating direction of an electromagnetic wave is inclined and directed toward the electromagnetic wave area E1 at the first stage and is set to radiate it from the front of a traveling direction −X·X of the RFID tags 3 on the dolly 8 along the conveying path 5 toward the electromagnetic wave area E1. In the embodiment shown in FIG. 1, the main antenna 21 is set to radiate electromagnetic waves from the front of the traveling direction −X·X of the RFID tags 3 to diagonally downward.

Therefore, the main antenna 21 has a function of establishing a data channel by an electromagnetic wave with the RFID tags 3₁ of which antenna surfaces incline toward the upper right among the RFID tags 3 which have traveled into the electromagnetic wave area E1 at the first stage.

The main antenna 22 is set such that a radiating direction of an electromagnetic wave is inclined and directed toward the electromagnetic wave area E3 at the last stage and is set to radiate it from the rear of a traveling direction −X·X of the RFID tags 3 on the dolly 8 along the conveying path 5 toward the electromagnetic wave area E3. In the embodiment shown in FIG. 1, the main antenna 22 is set to radiate electromagnetic waves from the rear of the traveling direction −X·X of the RFID tags 3 to diagonally downward.

Therefore, the main antenna 22 has a function of establishing a data channel by an electromagnetic wave between the main antenna 22 and the RFID tags 3₄ of which antenna surfaces incline toward the upper left among the RFID tags 3 which have traveled into the electromagnetic wave area E3 at the last stage.

With respect to the RFID tags 3₁ and 3₄ shown in FIG. 1, data channels can be established by electromagnetic waves radiated from the main antennas 21 and 22 in the electromagnetic wave areas E1 and E3 at the first stage and the last stage. However, in FIG. 1, data channels cannot be established by inclined electromagnetic waves from main antennas for the RFID tag 3₂ of which an antenna surface faces upward, and the RFID tag 3₃ of which an antenna surface faces sideways.

In the embodiments of the present invention, focusing attention on the antenna surfaces of the RFID tag 3₂ and the RFID tag 3₃ which face different directions respectively, the main antenna 23 is set to radiate electromagnetic waves from a direction intersecting with a traveling direction −X·X of the RFID tags 3 in the electromagnetic wave area E2 at the middle stage.

Specifically, the radiation of electromagnetic waves from the main antenna 23 is set at least in two directions intersecting with the traveling direction −X·X of the RFID tags 3. That is, the main antenna 13 put on such as a ceiling of a building above the conveying path 5 is disposed to radiate electromagnetic waves downward, then the electromagnetic waves (hereinafter called direct waves) 6b therefrom are irradiated directly onto the RFID tag 3₂ which directs the antenna surface thereof upward, in the meantime, the electromagnetic waves 6d therefrom with which articles does not interfere is reflected by the reflecting plate 4 and is directed in the horizontal direction or a nearly horizontal direction, and the reflected waves 7 are irradiated onto the RFID tag 3₃ of which the antenna surface faces sideways. The reflecting plates 4 are arranged in a plurality of stages vertically in one side of the electromagnetic wave area E2.

Therefore, using the reflecting plate 4 together, the main antenna 23 has a function of establishing data channels by electromagnetic waves between itself and the RFID tag 3₂ of which the antenna surface faces upward, and between itself and the RFID tag 3₃ of which the antenna surface faces sideways, among the RFID tags 3 which have traveled into the electromagnetic wave area E2 at the middle stage.

A plurality of reflecting plates 4 reflect the electromagnetic waves from the main antenna 2 of the reader/writer 1 and advance them towards the RFID tags 3 within the management area 5. Each of the reflecting plates 4 is so configured that the a reflecting surface 4a is formed on a surface to which an electromagnetic wave is made incident by metal finishing or applying an electromagnetic-reflecting agent so as to reflect the electromagnetic wave at the reflecting surface 4a. In the embodiment shown in FIG. 1, the reflecting plates 4 are arranged in four upper and lower stages in a vertical direction. Note that the number of arranged stages of the reflecting plates 4 is not limited to four. The number of arranged stages of the reflecting plates 4 changes depending on the piled height of the articles piled up on the dolly 8. For example, if the width of the reflecting plate 4 is narrow, the number of arranged stages of the reflecting plates 4 is large, and if the piled height of the articles piled up on the dolly 8 is high, the number of arranged stages of the reflecting plates 4 is large.

The plurality of reflecting plates 4 are arranged in multiple stages, and the reflecting surfaces 4a thereof are held in tilted postures. The tilt angle of the reflecting face 4a is set at an angle with which the electromagnetic waves 6a radiated from the main antenna 23 towards the directions of each reflecting plate 4 are reflected by the reflecting faces 4a in the horizontal direction or at an angle close to the horizontal direction, and the reflected waves 7 thereof are directed towards the RFID tags 3 attached, facing sideways, to the articles that are piled up stereoscopically.

The tilt angles of the reflecting plates 4 are changed in accordance with the positions where the electromagnetic waves 6b from the main antenna 2 make incident. In the case shown in the drawing, the tilt angle of the reflecting plate 4 for reflecting the electromagnetic wave 7 towards the RFID tag 3₃ positioned at the upper stage is set to be small, and the tilt angle of the reflecting plate 4 for reflecting the electromagnetic wave 7 towards the RFID tag 3₃ positioned at the lower stage is set to be large. Those tilt angles of the reflecting plates 4 are merely examples, so they may be selected appropriately by taking statistics of antenna directions of the RFID tags 3₂, 3₃ entered in the electromagnetic wave area E2, or according to the empirical rules. In other words, it is only necessary that electromagnetic waves 6b from the main antenna 23 of the reader/writer 13 can arrive at, especially, the antennas of the RFID tags 3₂, 3₃ in the electromagnetic wave area E2 by using the reflecting plates 4 having the reflecting surfaces 4a. Further, if the width of the reflecting plate 4a is in the same length of the wavelength of an electromagnetic wave or a length of ¾ or ½ of the wavelength, resonance phenomenon of the electromagnetic wave is caused on the reflecting surface 4a and attenuated, whereby the power of the reflected waves 7 is lowered. Therefore, the width of the reflecting plate 4 is set to be not less than the wavelength of the electromagnetic wave.

Further, the reflecting surface 4a of the reflecting plate 4 is formed in a shape of plane, two-dimensional parabolic face, cylindrical face, elliptical face or the like. If the shape of the reflecting surface 4a is a two-dimensional parabolic face, a cylindrical face, an elliptical face or the like, it is possible to suppress diffusion of the reflected wave from the reflecting surface 4a at minimum, compared with a reflecting surface 4a of a plane shape. Further, if the reflecting surface 4a is a two-dimensional parabolic face dished inward, a reflected wave shows a parallel radiation characteristic. If the reflecting surface 4a is a cylindrical face or an elliptical face dented inward, the reflected wave shows a condensing irradiation characteristic. The reflecting surface 4a may be in a shape of two-dimensional parabolic face, cylindrical face, elliptical face or the like protruded outwardly, depending on the cases.

Further, as the antenna provided to the RFID tag 3, an antenna of a general-purpose structure such as a flat antenna, a dipole antenna, a monopole antenna or a turnstile antenna is used. A turnstile antenna is an antenna in which two dipole antennas are combined in a positional relationship of 90 degrees to each other. Communications from the main antennas 21, 22, 23 to the antenna of the RFID tag 3 are performed by using a circularly polarized wave. When the antenna of the RFID tag 3 receives an electromagnetic wave, it can receive either of the clockwise-turning and counterclockwise-turning circularly polarized waves. If the antenna of the RFID tag 3 is a dipole antenna, a monopole antenna or a turnstile antenna, it can receive electromagnetic waves from front and back surface directions and from side surface directions. If the antenna of the RFID tag 3 is a flat antenna, it can receive electromagnetic waves from front and back surfaces directions of the RFID tag 3. The flat antenna includes a slot antenna, a patch antenna, a spiral antenna and the like.

As shown in FIG. 1, there is a sensor 26 set on the border of the electromagnetic wave areas E1 and E2, which detects the timing when the dolly 8 in the electromagnetic wave area E1 entering into the electromagnetic wave area E2. There is a sensor 27 set as well on the border of the electromagnetic wave areas E2 and E3, which detects the timing when the dolly 8 in the electromagnetic wave area E2 entering into the electromagnetic wave area E3. The sensors 26 and 27 are door shaped sensors and fixed on the both ends of the reflecting plates 4 arranged beside the conveying path 5. The sensors 26 and 27 comprise functions where the sensors 26 and 27 detect the dolly entering from the electromagnetic wave area E1 into the electromagnetic wave area E2, and entering from the electromagnetic wave area E2 into the electromagnetic wave area E3 respectively when the dolly 8 passes through the both end positions of the reflecting plates 4 and moves the door sensors 26 and 27, then the sensors 26 and 27 transmit the detecting signals to an antenna switching unit 25 which is described later.

Readers/writers 11, 12 and 13 are connected to the antenna switching unit 25 and the antenna switching unit 25 is connected to the computer terminal 15. The antenna switching unit 25 controls connections between the readers/writers 11, 12, 13 and the computer terminal 15 in accordance with the detecting signals outputted from the sensors 26 and 27. That is, before the sensor 26 detects the dolly entering from the electromagnetic wave area E1 into the electromagnetic wave area E2, the antenna switching unit 25 selects the reader/writer 11 since the antenna switching unit 25 determines that the dolly 8 is in the electromagnetic wave area E1. The antenna switching unit 25 then connects the selected reader/writer 11 and the computer terminal 15. This allows information to be exchanged between the computer terminal 15 and the reader/writer 11, and electromagnetic waves 6a from the reader/writer 11 is outputted from the main antenna 21 toward the electromagnetic wave area E1, so that a data channel is established between the main antenna 21 and the RFID tag 3₁ by the electromagnetic waves.

When the sensor 26 detects the dolly 8 entering from the electromagnetic wave area E1 into the electromagnetic wave area E2, the antenna switching unit 25 determines that the dolly 8 has entered in the electromagnetic wave area E2, whereby the antenna switching unit 25 disconnects the reader/writer 11 and selects the reader/writer 13 to connect the selected reader/writer 13 and the computer terminal 15. This allows information to be exchanged between the computer terminal 15 and the reader/writer 13, and the electromagnetic waves 6b from the reader/writer 13 is outputted from the main antenna 23 toward the electromagnetic wave area E2, so that a data channel is established between the main antenna 22 and the RFID tags 3₂, 3₃ by the electromagnetic waves.

When the sensor 27 detects the dolly 8 entering from the electromagnetic wave area E2 into the electromagnetic wave area E3, the antenna switching unit 25 determines that the dolly 8 has entered in the electromagnetic wave area E3, whereby the antenna switching unit 25 disconnects the reader/writer 13 and selects the reader/writer 12 to connect the selected reader/writer 12 and the computer terminal 15. This allows information to be exchanged between the computer terminal 15 and the reader/writer 12, and the electromagnetic waves 6c from the reader/writer 12 is outputted from the main antenna 22 toward the electromagnetic wave area E3, so that a data channel is established between the main antenna 23 and the RFID 3₄ by the electromagnetic waves.

The computer terminal 15 is connected to a server 17 by a network 16. Information from the computer terminal 15 is compiled in the server 17, and the information is outputted from the server 17 to the computer terminal 15 through the network 16. The server 17 compiles a database with inputted information from the reader/writer 1, and maintains the information being usable for stores in article management, or for factories in production management.

Next, action of the wireless communication system according to the embodiment of the present invention will be explained. The RFID tag 3 is attached to an article which is to be identified. The RFID tag 3 is written with necessary information to identify an article by an information writing device which is not shown in the drawing. The RFID tag 3 written with the information is attached to an article and is carried by the dolly 8 along the conveying path 5.

First, the RFID tags 3 are piled up on the dolly 8 and conveyed into the electromagnetic wave area E1 at the first stage. At this point, the antenna switching unit 25 does not receive a detecting signal from the sensors 26 and 27, so that the antenna switching unit 25 determines that the dolly 8 is in the electromagnetic wave area E1, and selects the reader/writer 11 to connect the selected reader/writer 11 and the computer terminal 15. This allows information to be exchanged between the computer terminal 15 and the reader/writer 11, and the electromagnetic waves 6a from the reader/writer 11 are outputted from the main antenna 21 toward the electromagnetic wave area E1, so that a data channel is established between the man antenna 21 and the RFID tag 3₁ by the electromagnetic waves.

The electromagnetic waves from the main antenna 21 is radiated from a diagonally upper position in front of the RFID tags 3 on the dolly 8 entering into the electromagnetic wave area E1. In this case, the RFID tag 3₁ of which the antenna surface inclines the upper right can receive the electromagnetic waves from the main antenna 21 among the RFID tags 3 on the dolly 8. The reader/writer 11 keeps radiating the electromagnetic waves continuously while the dolly 8 travels in the electromagnetic wave area E1, so that a plurality of the RFID tags 3₁ of which antenna surface faces the upper right receive the electromagnetic waves from the main antenna 21 and data communication is performed between the RFID tags 3₁ and the main antenna 21. Subsequently, the computer terminal 15 stores information of the RFID tags 3₁ which have completed communication with the reader/writer 11.

As time passes, the dolly 8 travels into the electromagnetic wave area E2 at the middle stage leaving away from the electromagnetic wave area E1 at the first stage. There is the sensor 26 set on the border of the electromagnetic wave area E1 at the first stage and the electromagnetic wave area E2 at the middle stage, and the sensor 26 detects the dolly 8 entering from the earlier stage of electromagnetic wave area E1 into the electromagnetic wave area E2 at the middle stage. When the sensor 26 detects the existence of the dolly 8, the detecting signals are transmitted to the antenna switching unit 25. The antenna switching unit 25 selects next reader/writer 13 instead of the reader/writer 11 upon receipt of the detecting signals from the sensor 26. This allows the selected reader/writer 13 and the computer terminal 15 to be connected each other, and information is exchanged between the computer terminal 15 and the reader/writer 13. The electromagnetic waves 6b from the reader/writer 13 is outputted from the main antenna 23 toward the electromagnetic wave area E2, so that a data channel is established between the main antenna 23 and the RFID tags 3₂ and 3₃ by the electromagnetic waves.

This method for establishing a data channel in the electromagnetic wave area E2 is different from the method for establishing a data channel in the electromagnetic wave areas E1 and E3 at the first stage and the last stage. That is, in the electromagnetic wave areas E1 and E3 at the first stage and the last stage, a data channel can be established only when the RFID tags 3 inclines toward the upper right or the upper left. However, the antenna surfaces of the RFID tags 3 on the dolly 8 are not always directed to the above mentioned directions, there are also the RFID tags 3₂ on the dolly 8, of which antenna surfaces face upward, or the RFID tags 3₃ on the dolly 8, of which antenna surfaces face sideways. It is impossible for one main antenna 23 to establish a data channel with respect to the RFID tags 3₂ and 3₃ of which the antenna surfaces face different directions. Therefore, in the electromagnetic wave area E2 at the middle stage, the electromagnetic waves are radiated in a direction intersecting with the traveling direction of the RFID tags 3 so as to establish a data channel.

The specific explanation will be followed. As shown in FIGS. 1 and 2, the radiating direction of the electromagnetic waves in the electromagnetic wave area E2 at the middle stage is set at least in two directions intersecting with the traveling direction of the RFID tags 3, and a data channel is established by the radiation of the electromagnetic waves from the two directions. That is, the electromagnetic waves 6b from the reader/writer 13 are radiated downward from the main antenna 23, and the direct waves 6b are radiated to the RFID tag 3₁ of which the antenna surface faces upward, thereby a data channel is established between the RFID tag 3₁ and the main antenna 23 by the direct waves 6b.

At the same time, electromagnetic wave 6b is radiated from the main antenna 23 to the reflecting plate 4, and the reflecting surface 4a of the reflecting plate 4 reflects the electromagnetic wave 6d in the horizontal direction or in a nearly horizontal direction. The reflected waves 7 are radiated toward the RFID tag 3₃ of which the antenna surface faces sideways, and thereby a data channel is established between the RFID tag 3₃ and the main antenna 23 using the reflecting plate 4.

Thus, in the electromagnetic wave area E2 at the middle stage, data channels are established between the RFID tags 3₂, 3₃ on the dolly 8 and the main antenna by the direct waves 6b radiated from the main antenna 23, and by the reflected waves 7 from the reflecting plate 4.

In this case, the reader/writer 13 keeps radiating the electromagnetic waves continuously to the main antenna 23 while the dolly 8 travels in the electromagnetic wave area E2, so that the RFID tag 3₂ of which the antenna surface faces upward receives the direct waves 6b from the main antenna 23, and the RFID tag 3₃ of which the antenna surface faces sideways receives the reflected waves 7 from the reflecting plate 4, and thereby data communication is performed between the RFID tags 3₂, 3₃ and the main antenna 23. Subsequently, the computer terminal 15 stores information of the RFID tags 3₂ and 3₃ which have completed communication with the reader/writer 13.

As time passes, the dolly 8 travels to the electromagnetic wave area E3 at the last stage leaving away from the electromagnetic wave area E2 at the middle stage. There is the sensor 27 set on the border of the electromagnetic wave area E2 at the middle stage and the electromagnetic wave area E3 at the last stage, and the sensor 27 detects the dolly 8 entering from the electromagnetic wave area E2 at the middle stage into the electromagnetic wave area E3 at the last stage. When the sensor 27 detects the existence of the dolly 8, the detecting signal is transmitted to the antenna switching unit 25. When the antenna switching unit 25 receives the detecting signals from the sensor 27, next reader/writer 12 is selected instead of the reader/writer 13. This allows the selected reader/writer 12 and the computer terminal 15 to be connected each other, so that information is exchanged between the computer terminal 15 and the reader/writer 12. The electromagnetic waves 6c from the reader/writer 12 are outputted from the main antenna 22 toward the electromagnetic wave area E3, and thereby a data channel is established between the main antenna 22 and the RFID tag 3₄ by the electromagnetic waves.

The electromagnetic waves from the main antenna 22 are radiated from the diagonally upper position in the rear of the RFID tags 3 on the dolly 8 entering into the electromagnetic wave area E3. In this case, the electromagnetic waves from the main antenna 22 can be received by the RFID tag 3₄ of which the antenna surface inclines the upper left among the RFID tags 3 on the dolly 8. The reader/writer 12 keeps radiating the electromagnetic waves continuously to the main antenna 22 while the dolly 8 travels in the electromagnetic wave area E3, and a plurality of the RFID tags 3₄ of which the antenna surfaces face the upper left receives the electromagnetic waves from the main antenna 22, so that data communication is performed between the RFID tags 3₄ and the main antenna 22. Subsequently, the computer terminal 15 stores information of the RFID tags 3₄ which have completed communication with the reader/write 12.

As described above, the RFID tags 3 on the dolly 8 travel through the electromagnetic wave area E1 at the first stage, the electromagnetic wave area E2 at the middle stage, and the electromagnetic wave area E3 at the last stage, whereby data channels are established between the RFID tags 3 of which antenna surfaces face random directions on the dolly 8 and the main antennas 21, 22, 23.

The computer terminal 15 obtains information of the RFID tags 3 on the dolly 8 from the reader/writers 11, 12 and 13, and sends it to the server 17 through the network 16. The server 17 organizes the information inputted from the reader/writer 1 into a database, and maintains the information so as to be usable in the goods management of a store, production management of a factory and the like.

As described above, according to the embodiment of the present invention, at least three main antennas are disposed above the conveying path 5 along a passage or a production line, and reflecting plates are set beside the conveying path 5. Each radiating direction of the electromagnetic waves by the radiating surfaces of main antennas and the radiating direction of the electromagnetic waves by the reflecting plates share different three directions; the X axis direction, the Y axis direction, and the Z axis direction. The electromagnetic waves are radiated from each of the main antennas and the reflecting plates toward the RFID tags in the different directions according to the position of the dolly traveling on the conveying 5, and communication is performed with the RFID tags. Thus, communication is certainly performed with every RFID tag accumulated on the dolly stereoscopically and facing random directions. Furthermore, a plurality of main antennas is switched in accordance with the position of the dolly traveling on the conveying path, which prevents antennas of the RFID tags from being interfered by incident electromagnetic wave from the plurality of the main antennas, also which prevents unnecessary radiation of electromagnetic waves.

### SECOND EMBODIMENT

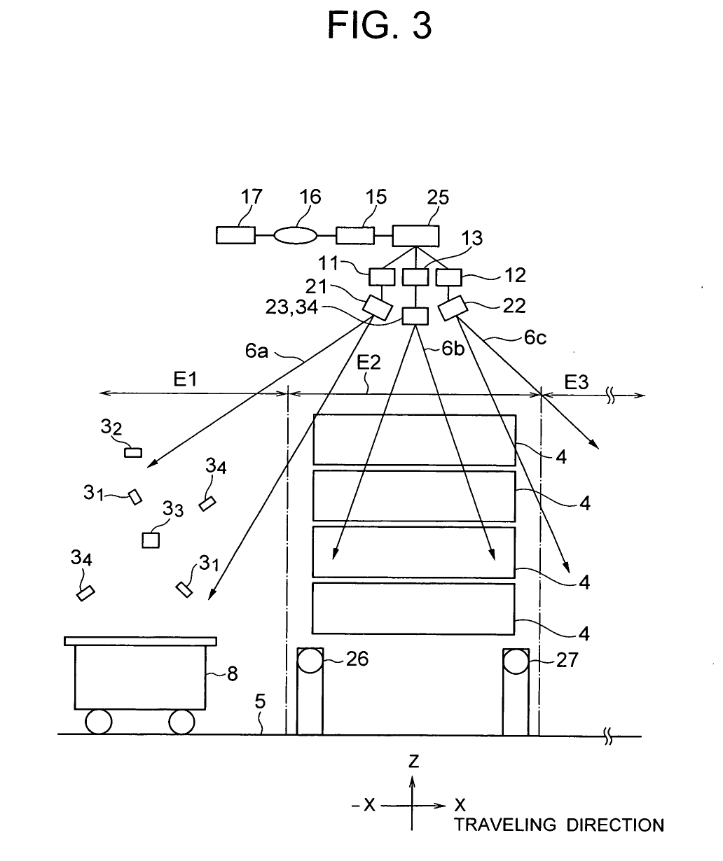

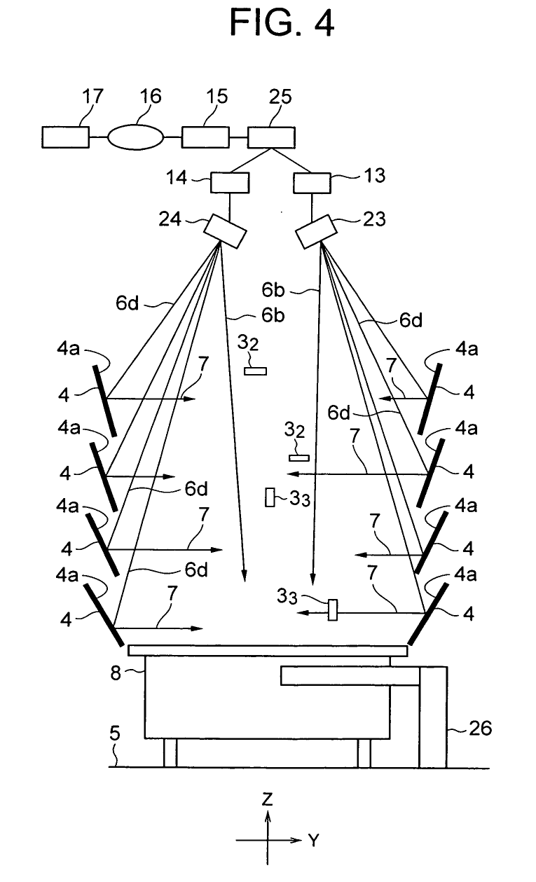

FIG. 3 is a side view showing a wireless communication system according to the second embodiment of the present invention. FIG. 4 is a front view showing a wireless communication system according to the second embodiment of the present invention.

The second embodiment of the present invention shown in FIGS. 3 and 4 is a modified configuration of the electromagnetic wave area E2 at the middle stage in the first embodiment. That is, the reflecting plates 4 are arranged in the both side of the conveying path 5 in the electromagnetic wave area E2 at the middle stage. A structure of each reflecting plate 4 arranged in the both side of the conveying path 5 is the same as the structure of the reflecting plates 4 shown in the first embodiment.

AS in the first embodiment, the reflecting plates 4 are arranged almost in the vertical direction by fittings and the like respectively on the walls which faces each other in a store or a factory, or on columns placed in the both side of a store or a production line 5 of a factory facing each other.

Moreover, in the embodiment of the present invention, a main antenna 24 is newly added besides the main antenna 23 within the electromagnetic wave area E2 at the middle stage in the first embodiment. The electromagnetic waves of the main antenna 23 are radiated downward and toward the reflecting plates 4 in the right shown in FIG. 4, and the electromagnetic waves of the main antenna 24 are radiated downward and toward the reflecting plates 4 in the left shown in FIG. 4.

Further, in the embodiment of the present invention, the antenna switching unit 25 selects the readers/writers 13 and 14 instead of the reader/writer 11 in accordance with the detecting signals from the sensor 26, and also selects two main antennas 23 and 24 instead of the main antenna 21 in the first stage while the dolly 8 travels in the electromagnetic wave area E2 at the middle stage. Then, the antenna switching unit 25 is to control the electromagnetic waves to be outputted from the reader/writer 13 to the main antenna 23, or from the reader/writer 14 to the main antenna 24 alternately according to the time-sharing control while the dolly 8 travels in the electromagnetic wave area E2 at the middle stage. Thus, these two main antennas 23 and 24 controlled by time-sharing perform read/write communication by establishing data channels with the RFID tags 3 on the dolly 8 by the electromagnetic waves.

The direct waves 6b from the main antennas 23 and 24 are radiated to the RFID tag 3₂ of which antenna surface faces upward. Further, the electromagnetic waves 6d radiated from the main antennas 23 and 24 toward the reflecting plates 4 are reflected by the reflecting surface 4a in the horizontal direction or in a nearly horizontal direction. The reflected waves 7 travel to the RFID tag 3₃ of which the antenna surface faces sideways on the dolly 8. The main antennas 23 and 24 are switched in order to prevent interference by electromagnetic wave incidence from the two main antennas 23 and 24 to the RFID tags 3. However, if interference does not occur since respective radiating regions of the main antennas do not cover each other at all, the main antennas 23 and 24 may not be switched. Other configurations are the same as ones in the first embodiment.

When the conveying path 5 along a passage or a production line is wide, or when the transmitting level of the electromagnetic waves radiated from the main antennas are low, a region where the reflected waves 7 cannot reach the RFID tags 3₂ and 3₃ on the dolly 8 is formed if the reflecting plates 4 are set only in one side.

Therefore, two readers/writers 13 and 14, and two main antennas 23 and 24 are used, and the radiating directions of the electromagnetic waves from the main antennas 23 and 24 are inclined toward the reflecting plates 4 arranged in the both side of the conveying path 5. The main antenna 23 performs communication with a right half of the RFID tags 3 on the dolly 8 as shown in FIG. 4 using the direct waves 6b and the reflected waves 7, and the main antenna 24 performs communication with a left half of the RFID tags 3 on the dolly 8 as shown in FIG. 4 using the direct waves 6b and the reflected waves 7.

The dolly 8 travels on the conveying path 5 along a passage or a production line in the traveling direction. When the dolly 8 enters into the electromagnetic wave area E1 at the first stage, that is, the region where the main antenna 21 radiates the electromagnetic waves, communication begins between the RFID tags 3 and the main antenna 21. The main antenna 21 communicates with the RFID tag 3₁ of which the antenna surface faces from the X axis direction to the Z axis direction, that is, the upper right direction, among the RIFD tags 3 of which the antenna surfaces face random directions accumulated on the dolly 8.

When the dolly 8 travels further in the traveling direction on the conveying path 5 along the passage or the production line, and enters into the electromagnetic wave area E2 at the middle stage, the sensor 26 detects the dolly 8 traveling beside the reflecting plates 4 and transmits the detecting signals to the antenna switching unit 25. The antenna switching unit 25 switches from the main antenna 21 for communication with the RFID tags 3 to the main antennas 23 and 24. The main antennas 23 and 24 communicate alternately by time-sharing with a RFID tag 3 facing the Z axis direction among the plurality of the RIFD tags 3, that is, the RFID tag 3₂ of which the antenna surface faces upward, by the direct waves 6b. Also the main antennas 23 and 24 communicate with a RFID tag 3 facing in the Y axis direction, that is, the RFID tag 3₃ of which antenna surface faces sideways.

The dolly 8 travels further and the sensor 27 detects the dolly 8 leaving out of the reflecting plates 4 side and entering into the electromagnetic wave area E3 at the last stage from the electromagnetic wave area E2 at the middle stage. Then the sensor 27 transmits the detecting signals to the antenna switching unit 25. The antenna switching unit 25 switches from the main antennas 23 and 24 for communication with the RFID tags 3 to the main antenna 22.

The main antenna 22 communicates with a RFID tag 3 facing from the −X axis direction to the Z axis direction among the plurality of the RFID tags 3, that is, the RFID tag 3₄ of which the antenna surface faces the upper left. The dolly 8 travels further and leaves out of the region where the main antenna 22 radiates the electromagnetic wave, namely, the electromagnetic wave area E3 at the last stage. Then the communication between the RFID tags 3 and antennas has been completed.

The computer terminal 15 outputs the control signals to the reader/writer 11 and the main antenna 21, the reader/writer 12 and the main antenna 22, the reader/writer 13 and the main antenna 23, or the reader/writer 14 and the main antenna 24, which are switched along the travel of the dolly 8, in order that the readers/writers and the main antennas perform communication with the RFID tags 3 piled up stereoscopically on the dolly repeatedly. Each main antenna transmits inquiry signals to the RFID tags 3 repeatedly, and communicates with respective RFID tags 3 which have responded. The communication is completed after several times of communication between each of the RFID tags 3 and main antennas. The computer terminal 15 stores respective identifying numbers of the RFID tags 3 which have responded and have completed the communication.

As described in the above, according to the present embodiment, at least four main antennas are disposed above the conveying path 5 along the passage or the production line and reflecting plates are arranged beside the conveying path 5. Each main antenna shares three different directions, the X axis direction, the Y axis direction and the Z axis direction, to radiate the electromagnetic waves. The main antennas and the reflecting plates radiate the electromagnetic waves from the different directions toward the RFID tags in accordance with a position of the dolly which travels through a passage or a production line, and communication is performed with the RFID tags. Thus, communication can be certainly performed with all RFID tags which are piled up stereoscopically on the dolly and face random directions. Moreover, a plurality of the main antennas is switched in accordance with a position of the dolly traveling on the conveying path, whereby interference on the antennas of the RFID tags by electromagnetic wave incidence from the plurality of the main antennas is prevented, whereby unnecessary radiation of the electromagnetic waves are prevented.

In the above described embodiment, the main antennas 21, 22, 23 and 24 are disposed at every electromagnetic wave area E1, E2 and E3, however, the configurations are not limited to this. A single main antenna which moves around the plurality of electromagnetic wave areas E1, E2 and E3 may be disposed so as to radiate electromagnetic waves from three-dimensional directions at every electromagnetic wave area E1, E2 and E3.

Although the present invention is applied to manage articles in the embodiments described above, the present invention is not limited to this configuration. Wireless IC chips (e.g., RFID tags) may be attached to articles, members or devices transferred through belt conveyers or by dollies so as to manage them. Further, wireless IC chips (e.g., RFID tags) may be attached to articles, members or devices stored in a factory, a warehouse or a distribution channel so as to manage them. Moreover, wireless IC chips (e.g., RFID tags) may be held by or attached to humans or animals to thereby apply the present invention in recognizing the humans or individuals, or in managing entrance and exit.

### INDUSTRIAL APPLICABILITY

According to the present invention as described above, main antennas share three different directions, the X axis, the Y axis and the Z axis, to radiate electromagnetic waves, and radiate the electromagnetic waves toward wireless IC tags from each different direction for communication with the wireless IC chips. Thus, reliable data communication can be achieved for every wireless chip which is accumulated stereoscopically and faces random directions.

What is claimed is:

1. A wireless communication system comprising:
a plurality of electromagnetic wave areas to form a data channel between a wireless IC chip and a main antenna, wherein
the plurality of electromagnetic wave areas are arranged along a traveling direction of the wireless IC chip; and
the plurality of electromagnetic wave areas has:
an electromagnetic wave area at a first stage in which an electromagnetic wave is radiated from front of a traveling direction of the wireless IC chip,
an electromagnetic wave area at a middle stage in which an electromagnetic wave is radiated in a direction intersecting with a traveling direction of the wireless IC chip, and
an electromagnetic wave area at a last stage in which an electromagnetic wave is radiated from a rear of a traveling direction of the wireless IC chip.

2. The wireless communication system, as claimed in claim 1, wherein a radiation of an electromagnetic wave is set at least in two directions intersecting with a traveling directions of the wireless IC chip.

3. The wireless communication system, as claimed in claim 1, wherein a unit is provided which switches an electromagnetic wave radiation from main antennas in the plurality of electromagnetic wave areas by synchronizing the radiation with travel of a wireless IC chip.

4. The wireless communication system, as claimed in claim 1, wherein a reflecting plate which reflects an electromagnetic wave radiated from the main antenna toward a traveling direction of a wireless IC chip is arranged in an electromagnetic wave area at a middle stage among the plurality of electromagnetic wave areas.

5. The wireless communication system, as claimed in claim 4, wherein the main antenna is disposed taking the reflecting plate as a unit.

6. A method of wireless communication with which communication is performed establishing a data channel by an electromagnetic wave between a wireless IC chip and a main antenna, the method comprising the steps of:
a preliminary process in which the wireless IC chip travels into a plurality of electromagnetic wave areas sequentially; and
a communication process in which an electromagnetic wave is radiated from different directions at every electromagnetic wave area toward a wireless IC chip that has traveled into the electromagnetic wave areas, wherein
an electromagnetic wave is radiated from front of a traveling direction of the wireless IC chip in an electromagnetic wave area at a first stage among the plurality of electromagnetic wave areas,
an electromagnetic wave is radiated in a direction intersecting with a traveling direction of the wireless IC chip in an electromagnetic wave area at a middle stage among the plurality of electromagnetic wave areas, and
an electromagnetic wave is radiated from a rear of a traveling direction of the wireless IC chip in an electromagnetic wave area at a last stage among the plurality of electromagnetic wave areas.

7. The method of wireless communication, as claimed in claim 6, wherein an electromagnetic wave is radiated at least in two directions intersecting with a traveling direction of the wireless IC chip.

8. The method of wireless communication, as claimed in claim 7, wherein radiation of an electromagnetic wave in the plurality of electromagnetic wave areas is switched, being synchronized with travel of a wireless IC chip.

9. The method of wireless communication, as claimed in claim 6, wherein the plurality of electromagnetic wave areas is equipped respectively with main antennas which radiate an electromagnetic wave in different directions.

10. The method of wireless communication, as claimed in claim 6, wherein a single main antenna moves around the plurality of electromagnetic wave areas so as to radiate an electromagnetic wave in different directions at every electromagnetic wave area.

11. The method of wireless communication, as claimed in claim 6, wherein an electromagnetic wave is radiated at least in two directions intersecting with a traveling direction of the wireless IC chip in the middle stage of electromagnetic wave area.
